(19) United States
(12) Patent Application Publication
(10) Pub. No.: US 2018/0341072 A1
(43) Pub. Date: Nov. 29, 2018

(54) FIBER OPTIC CONNECTION SYSTEM WITH ENCLOSURE PORT PLUGS

(71) Applicant: COMMSCOPE TECHNOLOGIES LLC, Hickory, NC (US)

(72) Inventors: Thomas MARCOUILLER, Shakopee, MN (US); Oscar Fernando BRAN DE LEÓN, Belle Plaine, MN (US)

(21) Appl. No.: 15/779,004

(22) PCT Filed: Nov. 22, 2016
(86) PCT No.: PCT/US2016/063337

§ 371 Date: May 24, 2018

Related U.S. Application Data
(60) Provisional application No. 62/259,279, filed on Nov. 24, 2015.

(51) Int. Cl. G02B 6/38; G02B 6/44

(52) U.S. Cl. CPC G02B 6/3897; G02B 6/3893; G02B 6/3825; G02B 6/4472

(57) ABSTRACT

A fiber optic connection system includes an enclosure, at least one fiber optic adapter, and at least one enclosure port plug. The adapter can be removably secured at a port defined in the enclosure to mate fiber optic connectors therethrough. The enclosure port plug can be removably secured at the port and replaceable by the adapter.

### CROSS-REFERENCE TO RELATED APPLICATION

This application is being filed on Nov. 22, 2016 as a PCT International Patent Application and claims the benefit of U.S. Patent Application Ser. No. 62/259,279, filed on Nov. 24, 2015, the disclosure of which is incorporated herein by reference in its entirety.

### TECHNICAL FIELD

The present disclosure relates generally to a fiber optic connection system. More particularly, the present disclosure relates to a fiber optic connection system having an enclosure with ruggedized ports.

### BACKGROUND

Fiber optic communication networks are used to deliver high bandwidth communication capabilities (e.g., data and voice) to customers or subscribers. Fiber optic communication networks employ a network of fiber optic cables to transmit large volumes of data and voice signals over relatively long distances. Such fiber optic communication networks further employ fiber optic cable connection systems that are used to facilitate connecting and disconnecting fiber optic cables in the field without requiring a splice.

A typical fiber optic cable connection system for interconnecting two fiber optic cables includes fiber optic connectors mounted at the ends of the fiber optic cables, and a fiber optic adapter for mechanically and optically coupling the fiber optic connectors together. Fiber optic connectors generally include ferrules that support the ends of the optical fibers of the fiber optic cables. The end faces of the ferrules are typically polished and are often angled. The fiber optic adapter includes co-axially aligned ports (i.e., receptacles) for receiving the fiber optic connectors desired to be interconnected. The fiber optic adapter includes an internal sleeve that receives and aligns the ferrules of the fiber optic connectors when the connectors are inserted within the ports of the fiber optic adapter. With the ferrules and their associated fibers aligned within the sleeve of the fiber optic adapter, a fiber optic signal can pass from one fiber to the next. The adapter also typically has a mechanical fastening arrangement (e.g., a snap-fit arrangement) for mechanically retaining the fiber optic connectors within the adapter. One example of an existing fiber optic connection system is described in U.S. patent application Ser. No. 12/203,508 entitled HARDENED FIBER OPTIC CONNECTOR COMPATIBLE WITH HARDENED AND NON-HARDENED FIBER OPTIC ADAPTERS, filed Sep. 3, 2008, now U.S. Pat. No. 7,744,288 issued Jun. 29, 2010, the disclosure of which is hereby incorporated by reference.

A fiber optic cable connection system can include a fiber optic terminal (also referred to as a fiber distribution terminal or multi-service terminal). In certain examples, fiber optic communication networks can extend to multi-dwelling units such as apartment buildings or condominiums. As part of various fiber-to-the-premises (FTTP), fiber-to-the-home (FTTH), and other initiatives (generally described as FTTx), such fiber optic networks direct optical signals from distribution cables through local convergence points to fiber optic cables, such as drop cables, that are either directly or indirectly run to the subscribers' premises. Optical fibers routed to subscribers' premises can be routed via the fiber optic terminal en route to the premises. At the fiber drop terminal, signals appearing on one or more optical fibers may be routed to one or more end user premises. Fiber drop terminals may be mounted in aerial applications, such as near the tops of utility poles. Fiber drop terminals may also be installed in junction boxes mounted at ground level and/or in below-grade vaults where utilities are run below ground.

Fiber optic terminals typically provide a plurality of ports or receptacles for securing the fiber optic adapters to distribute signals from a main cable to one or more drop cables. In certain situations, only one or some of the adapters are used for signal distribution, and the rest of the adapters secured in the ports of the fiber optic terminal are typically covered with adapter plugs or caps until they are in use. Although the caps are configured to protect the unused adapters in the fiber optic terminal, the adapters and associated components of the fiber optic terminal can be still exposed to contamination in the field.

### SUMMARY

Teachings of the present disclosure relates to a fiber optic connection system including a fiber optic enclosure with one or more plugs that cover adapter ports defined in the fiber optic enclosure. The adapter ports are configured to engage fiber optic adapters. The plugs and the fiber optic adapters can be interchangeably secured to the adapter ports. The plugs can engage one or some of the adapter ports defined in the fiber optic enclosure, thereby adjusting the number of adapter ports available for fiber optic connections through fiber optic adapters. As such, the fiber optic connection system can provide different ports counts for fiber optic connections with a single fiber optic enclosure. The plugs are designed to delay fiber optic connections until the plugs are replaced by fiber optic adapters for mating fiber optic connectors. In certain examples, the plugs are configured as parking devices for temporarily storing a fiber optic connector within the enclosure until the fiber optic adapters replace the plugs.

Some aspects of the disclosure relate to a fiber optic connection system. The system may include an enclosure including a plurality of ports, at least one adapter, and at least one enclosure port plug. The adapter is removably secured at the port and configured to mate a first fiber optic connector and a second fiber optic connector. The adapter has a first receptacle and a second receptacle. The first receptacle is open to an interior of the enclosure and configured to engage the first fiber optic connector, and the second receptacle is open to an exterior of the enclosure and configured to engage the second fiber optic connector. The enclosure port plug may be removably secured at the port and replaceable by the adapter.

In certain examples, the enclosure port plug may be inserted into the port from the exterior of the enclosure and includes a receiving cavity configured to engage the first fiber optic connector. The enclosure port plug may include a ferrule support sleeve arranged at the receiving cavity and configured to receive a ferrule of the first fiber optic connector.

In certain examples, the enclosure port plug may be secured to the enclosure through the port by sandwiching the enclosure between the plug head and a mounting nut. The plug head may be configured to seat on a portion of the enclosure circumferentially around the port, and the mounting nut is located inside the enclosure. In some examples, a sealing member is disposed between the enclosure port plug and the enclosure to provide sealing of the plug around the port.

In certain examples, the enclosure port plug is secured to the port in the same manner as the adapter. In some examples, the enclosure port plug is secured at the port with the mounting nut. In other examples, the enclosure port plug is threadedly engaged with the port. In yet other examples, the plug is snap-fit to the port.

Other aspects of the disclosure relate to a method for managing fiber optic connection. The method may include engaging a first plug with a first port defined in a fiber optic enclosure to close the first port; and engaging a first fiber optic adapter with a second port defined in the fiber optic enclosure. The first fiber optic adapter may be configured to mate one of first fiber optic connectors and one of second fiber optic connectors. The first fiber optic connectors are configured to be inserted into the first fiber optic adapter from an interior of the enclosure, and the second fiber optic connectors are configured to be inserted into the first fiber optic adapter from an exterior of the enclosure.

In certain examples, the method may further include removing the first plug from the first port; and engaging a second fiber optic adapter with the first port, the second fiber optic adapter configured to mate one of the first fiber optic connectors and one of the second fiber optic connectors.

In certain examples, the method may further include inserting one of the first fiber optic connectors to the first plug.

Yet other aspects of the disclosure relate to a fiber optic plug for providing a delayed fiber optic connection. The fiber optic plug may include a plug head and a plug body. The plug head may cover an adapter port of a fiber optic enclosure. The adapter port is configured to secure a fiber optic adapter. The plug body is configured to extend from the plug head and may be inserted through the adapter port.

In certain examples, the enclosure port plug may be secured to the enclosure through the port by sandwiching the enclosure between the plug head and a mounting nut. The plug head may be configured to seat on a portion of the enclosure circumferentially around the port, and the mounting nut is located inside the enclosure. In some examples, a sealing member is disposed between the enclosure port plug and the enclosure to provide sealing of the plug around the port.

In certain examples, the plug body may define a receiving cavity and include a connector support portion within the receiving cavity. The connector support portion can be configured to receive and support at least a portion of the fiber optic connector.

In certain examples, the connector support portion may engage the fiber optic connector by interference-fit.

In certain examples, the plug body may include a ferrule support sleeve configured to receive and support a ferrule of the fiber optic connector when the fiber optic connector is received into the receiving cavity.

The above features and advantages and other features and advantages of the present teachings are readily apparent from the following detailed description of examples for carrying out the present teachings when taken in connection with the accompanying drawings.

### BRIEF DESCRIPTION OF THE DRAWINGS

FIG. 1 is a perspective view of an example fiber optic connection system in accordance with the principles of the present disclosure.

FIG. 2 illustrates an example of an interior of the fiber optic enclosure.

FIG. 3 is a perspective view of the fiber optic enclosure, illustrating ports, fiber optic adapters, and plugs in more detail.

FIG. 4A is a cross sectional view of the fiber optic enclosure.

FIG. 4B is a cross sectional view of the fiber optic enclosure with a second fiber optic connector.

FIG. 5A schematically illustrates an enclosure port plug engaging a fiber optic connector.

FIG. 5B schematically illustrates the enclosure port plug before the fiber optic connector is inserted into the enclosure port plug.

FIG. 6A is a top view of the enclosure port plug.

FIG. 6B is a side view of the enclosure port plug.

FIG. 6C is another side view of the enclosure port plug.

FIG. 6D is a bottom view of the enclosure port plug.

### DETAILED DESCRIPTION

Various examples will be described in detail with reference to the drawings, wherein like reference numerals represent like parts and assemblies throughout the several views.

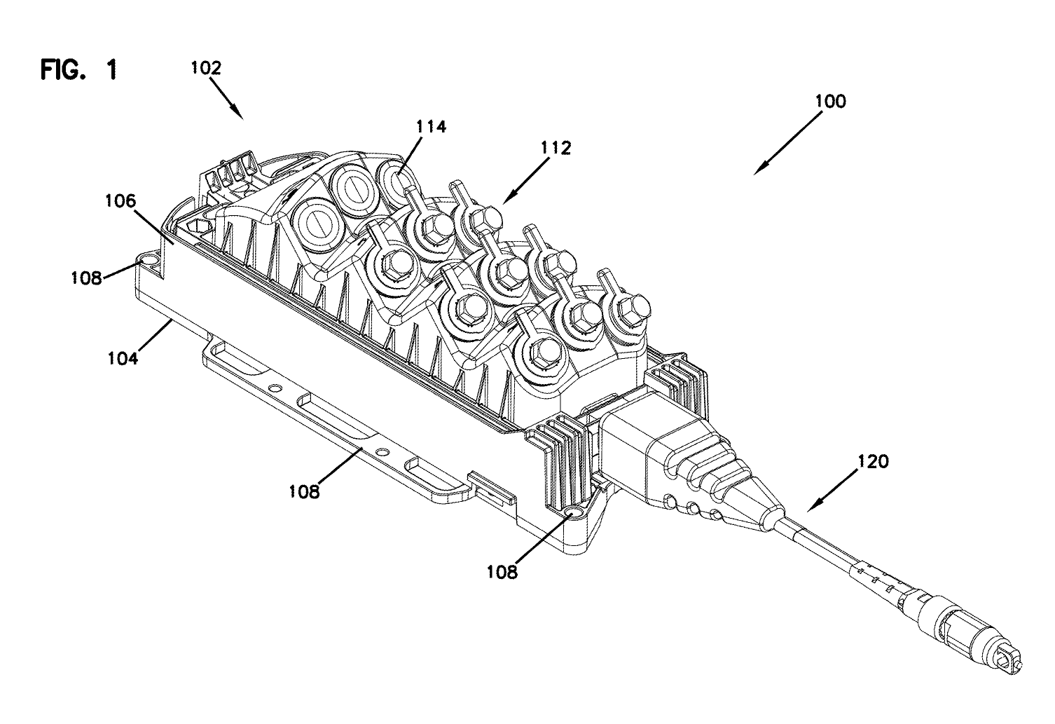

FIG. 1 is a perspective view of an example fiber optic connection system 100 in accordance with the principles of the present disclosure. The system 100 includes a fiber optic enclosure 102. The fiber optic enclosure 102 may be deployed in various environments including aerial (such as near the top of a utility pole), pedestal (such as cabinets accessible when standing on grade), and/or below grade (such as in below grade vaults and/or sealed enclosures). The fiber optic enclosure 102 may include two parts sealed by a flexible sealing interface that operates to seal an internal cavity. In some embodiments, the enclosure 102 includes a base 104 and a housing 106.

The fiber optic enclosure 102 can be of various types. Examples of the fiber optic enclosure 102 include fiber drop terminal, pedestals, network interface devices, fiber distribution hubs, splice enclosures, and optical network terminals.

The base 104 is releasably attached to the housing 106 using, for example, fasteners, keyed retainers, clamping devices, and other elements suitable to couple the base 104 and the housing 106. In some embodiments, the base 104 has a substantially flat shape configured to retain a gasket and/or other sealing device along a base mounting surface that may be releasably coupled to a corresponding housing mounting surface associated with the housing 106. In some embodiments, the base 104 includes a mounting portion 108 adapted for attachment to a surface, such as a utility pole, using fasteners, such as nails, and/or screws.

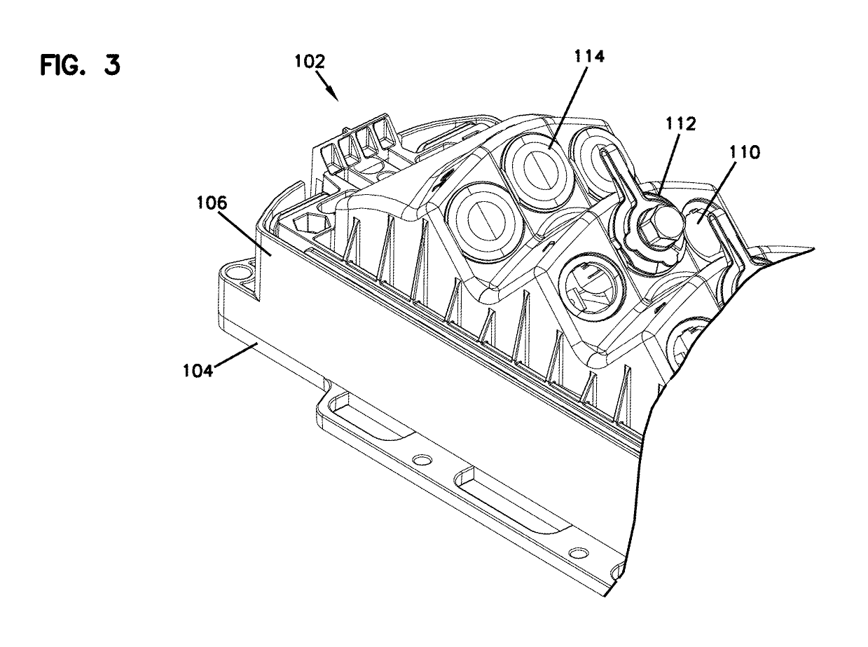

The housing 106 is configured to define a cavity or interior for housing optical fibers and connectors. The housing 106 defines a plurality of ports 110 (FIG. 3) passing therethrough. As described herein, the ports 110 are configured to secure fiber optic adapters 112 and plugs 114. The housing 106 may be shaped such that an upper surface of the base 104 operates to form an enclosed space in conjunction with the interior of the housing 106 when coupled to the housing 106. In some embodiments, the housing 106 may be configured to provide a fiber management portion within the interior thereof for storing excess optical fibers.

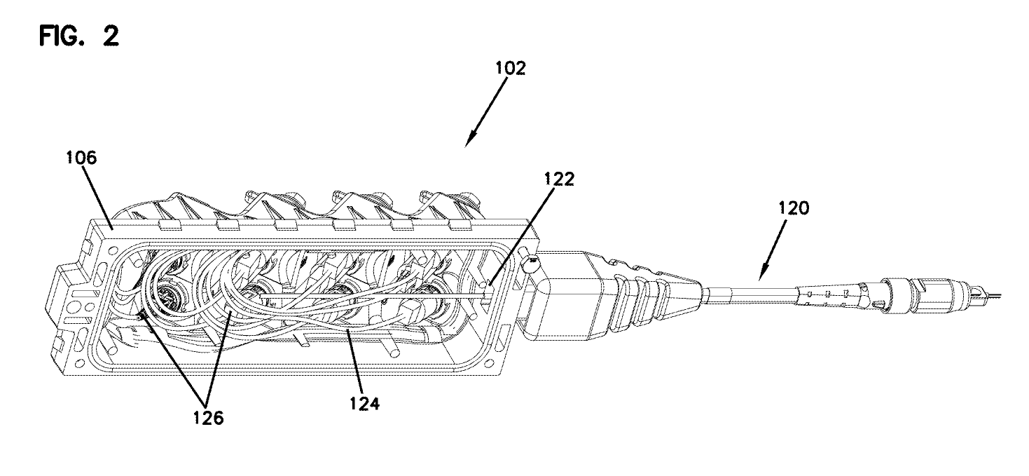

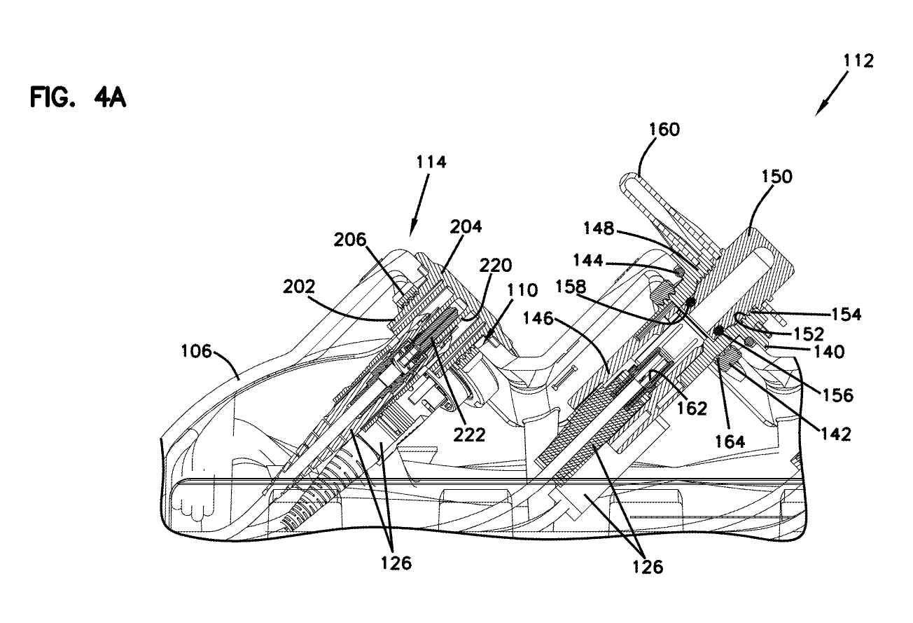

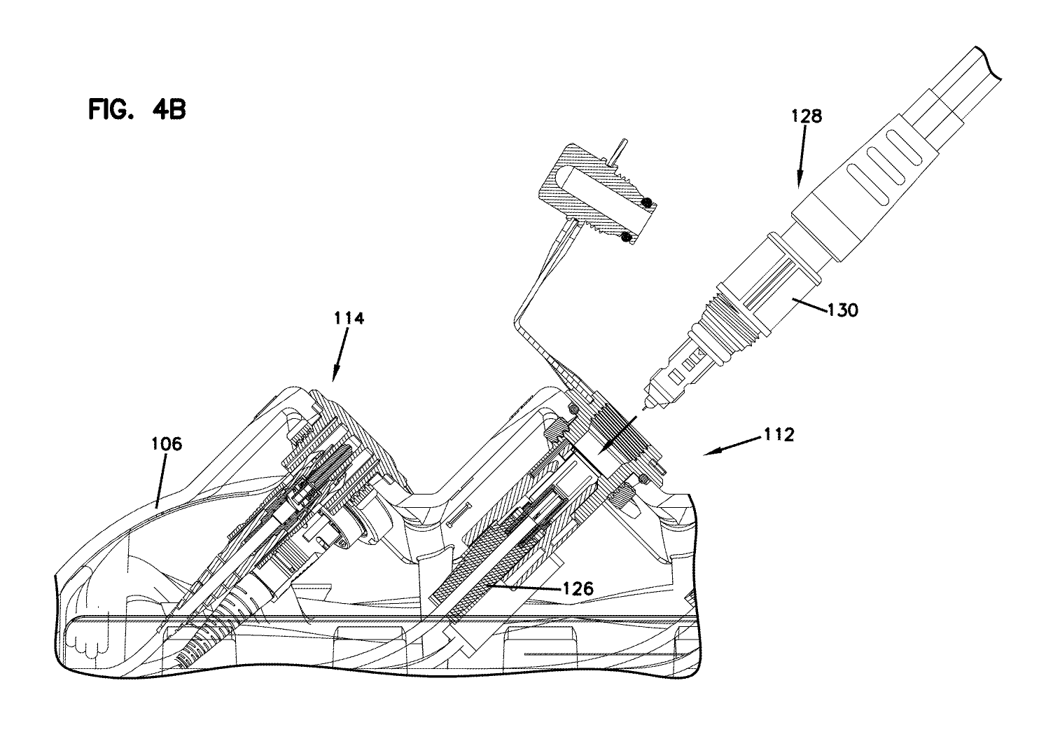

The fiber optic connection system 100 includes at least one fiber optic adapter 112 for mating a first fiber optic connector 126 (FIG. 2) and a second fiber optic connector 128 (FIG. 4B). The adapter 112 is configured to be mounted through the port 110 (FIG. 3) defined in the enclosure 102. An example of the adapter 112 is described and illustrated in more detail with reference to FIGS. 4A and 4B.

The fiber optic connection system 100 further includes at least one enclosure port plug 114 configured to close the port 110 of the enclosure 102. One or more plugs 114 are used to cover one or more of the ports 110 and make the remaining the ports 110 available for fiber optic connections. As described herein, when a fiber optic connection is required through a particular port 110, the plug 114 that closes the port 110 is removed and replaced by an adapter 112. In some embodiments, the removed plug 114 can be placed or stored in different places. In other embodiments, the removed plug 114 can be discarded. In yet other embodiments, the removed plug 114 can be secured in a different port 110. An example of the enclosure port plug 114 is described and illustrated in more detail with reference to FIGS. 4-6.

FIG. 2 illustrates an example of the interior of the fiber optic enclosure 102. The fiber optic enclosure 102 includes a channel configured to receive a fiber bundle or input cable 120. The input cable 120 may include one or more input optical fibers enclosed within a protective sheath, or tube, for coupling incoming optical signals with one or more output connectors (i.e., second fiber optic connectors) via the adapters 112. The number of input optical fibers can depend on the number of ports 110 defined in the enclosure 102. For example, if the enclosure 102 includes eight ports 110, the input cable 120 may include eight optical fibers. An incoming optical fiber may be associated with a particular output port. The quantity of fibers within the input cable 120 may match the number of ports 110, may exceed the number of ports 110, and/or may be fewer than the number of ports 110. The incoming fibers may terminate with an industry standard SC/APC connector.

The input cable 120 may enter the enclosure 102 through an input channel 122. The input channel 122 may include a passage or tubular entrance through which the input cable 120 may pass. Individual cables or fibers 124 may be fanned out from the input cable 120 once inside the inner cavity of the enclosure 102. The input cable 120 may be sealed to the input channel 122 using, for example, sealing techniques (e.g., heat shrink sleeves, overmold, potting materials, etc.) known in the art. The input channel 122 may be adapted to receive an input receptacle or adapter for receiving incoming fibers. When the input channel 122 is fitted with an adapter or receptacle, the input cable 120 may be terminated with a mating input connector for coupling optical signals to the input receptacle and/or to the adapter 112.

The internal cables 124 branched out from the input cable 120 within the enclosure 102 may be terminated using first fiber optic connectors 126. In some embodiments, the first fiber optic connectors 126 are SC connectors. One example of an SC connector is illustrated and described in U.S. Pat. No. 5,317,663, which is hereby incorporated by reference in its entirety. In other embodiments, the first fiber optic connectors 126 can be of different types.

The adapter 112 is configured to mate the first fiber optic connector 126 and a second fiber optic connector 128 therethrough. The adapter 112 defines a first receptacle (e.g., an unhardened first port 146) open toward the interior of the enclosure 102 and a second receptacle (e.g., a hardened second port 148) open toward the exterior of the enclosure 102. The first fiber optic connector 126 is inserted into the first receptacle 146 from the interior of the enclosure 102, and the second fiber optic connector is inserted into the second receptacle 148 from the exterior of the enclosure 102. In some embodiments, the second fiber optic connector 128 is configured as a hardened or ruggedized connector (e.g., a modified SC/APC connector) that is strengthened to increase its durability to meet, for example, outdoor environments. Correspondingly, the first receptacle 146 is hardened or ruggedized. By hardened or ruggedized, it is meant that the second fiber optic connector 128 and the adapter 112 are adapted for outside environmental use. For example, the second fiber optic connector 128 and the adapter 112 can include environmental seals for preventing moisture/water intrusion. For example, the second fiber optic connector 128 may include modifications to provide weather and UV protection to an optical fiber inside the connector. The second fiber optic connector 128 may also be adapted to increase the pull-out force of the fiber from the connector and/or connector from a receptacle. In some examples, the second fiber optic connector 128 includes a rotatable fastener 130 (e.g., a nut or bayonet style fastener) that interfaces with the adapter 112 to provide the second fiber optic connector 128 with a pull-out resistance exceeding 25 pounds or 50 pounds. The second fiber optic connector 128 and the adapter 112 can form a watertight assembly when coupled together using, for example, threaded sleeves. In one implementation, the second fiber optic connector 128 and/or the adapter 112 are equipped with O-rings to provide radial seals within each adapter 112 when mated to the second fiber optic connector. The second fiber optic connector 128 may also be equipped with one or more O-rings proximate to an interface between the adapter 112 and the housing 106.

Referring to FIGS. 3 and 4, the adapters 112 and the plugs 114 are described in connection to the enclosure 102. FIG. 3 is an expanded view of the fiber optic enclosure 102, and FIGS. 4A and 4B are cross sectional views of the fiber optic enclosure 102.

As illustrated in FIG. 3, the adapters 112 are secured at some of the ports 110 of the enclosure 102, and the plugs 114 are secured to other ports 110 of the enclosure 102. The plugs 114 are used to selectively close one or more of the ports 110 of the enclosure 102 and allow the other ports 110 to engage the adapters 112 for fiber optic connections.

Referring to FIGS. 4A and 4B, the adapter 112 is removably mounted at the port 110 of the enclosure 102. In some embodiments, the adapter 112 is secured to the enclosure 102 through the port 110 by sandwiching the enclosure 102 between an adapter flange 140 and a mounting nut 142. The adapter 112 includes a threaded portion 164 at an exterior of the adapter 112 that is configured to engage the mounting nut 142 opposite to the adapter flange 140. When the adapter 112 is secured to the enclosure 102, the adapter flange 140 is arranged outside the enclosure 102 and the mounting nut 142 is located inside the enclosure 102. In other embodiments, the adapter 112 is configured such that the adapter flange 140 is arranged inside the enclosure 102 while the mounting nut 142 is located outside the enclosure 102.

A sealing member 144 (e.g., O-ring) can be provided to environmentally seal the adapter 112 around the port 110 of the enclosure 102. The adapter 112 includes an unhardened first port 146 for receiving an internal fiber optic connector (i.e., the first fiber optic connector 126) and a hardened second port 148 for receiving an external fiber optic connector (not shown). One example of the adapter is illustrated and described in U.S. patent application Ser. No. 12/203,508 entitled HARDENED FIBER OPTIC CONNECTOR COMPATIBLE WITH HARDENED AND NON-HARDENED FIBER OPTIC ADAPTERS, filed Sep. 3, 2008, now U.S. Pat. No. 7,744,288 issued Jun. 29, 2010, and U.S. patent application Ser. No. 11/657,402 entitled HARDENED FIBER OPTIC CONNECTOR, filed Jan. 24, 2007, now U.S. Pat. No. 7,572,065 issued Aug. 8, 2009, both of which are hereby incorporated by reference in their entireties. In some embodiments, the adapters 112 can be mounted to a drop terminal of the type disclosed in U.S. patent application Ser. No. 11/075,847, entitled FIBER ACCESS TERMINAL, filed on Mar. 8, 2005, now U.S. Pat. No. 7,292,763 issued Nov. 8, 2007, which is hereby incorporated by reference in its entirety. In other embodiments, one or more of the adapters 112 can be mounted to a network interface device of the type disclosed in U.S. patent application Ser. No. 11/607,676, entitled NETWORK INTERFACE DEVICE, filed on Dec. 1, 2006, now U.S. Pat. No. 8,135,256, which is hereby incorporated by reference in its entirety.

The adapter 112 may be plugged with an adapter plug 150, when not in use, to prevent dirt and moisture from accumulating on a fiber within the adapter 112. For example, the adapter plug 150 is inserted into the hardened port 148 of the adapter 112 to seal the hardened port 148 of the adapter 112. To install the adapter plug 150 in the adapter 112, a threaded portion 152 of the adapter plug 150 is inserted into the hardened port 148 of the adapter 112 and the threaded portion 152 is screwed into a threaded portion 154 of the adapter 112. Environmental sealing between the adapter plug 150 and the adapter 112 can be accomplished by an O-ring 156 mounted on the adapter plug 150 which seals against a sealing surface 158 of the adapter 112. In some embodiments, the adapter plug 150 is retained to the adapter 112 by a strap 160. A first end of the strap 160 is connected to the adapter 112 and a second end of the strap 160 is connected to the adapter plug 150.

In some embodiments, the adapter 112 includes an alignment sleeve 162 that receives and aligns a ferrule of the first connector 126 inserted into the internal port 146 and a ferrule of the second connector (not shown) inserted into the external port 148.

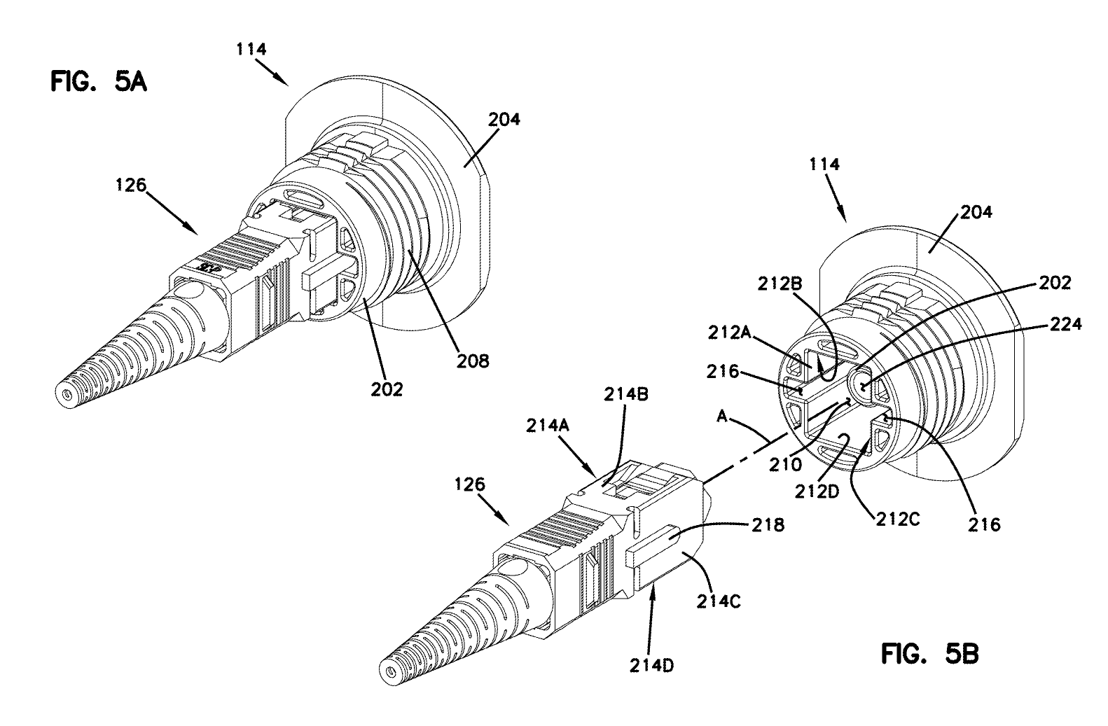

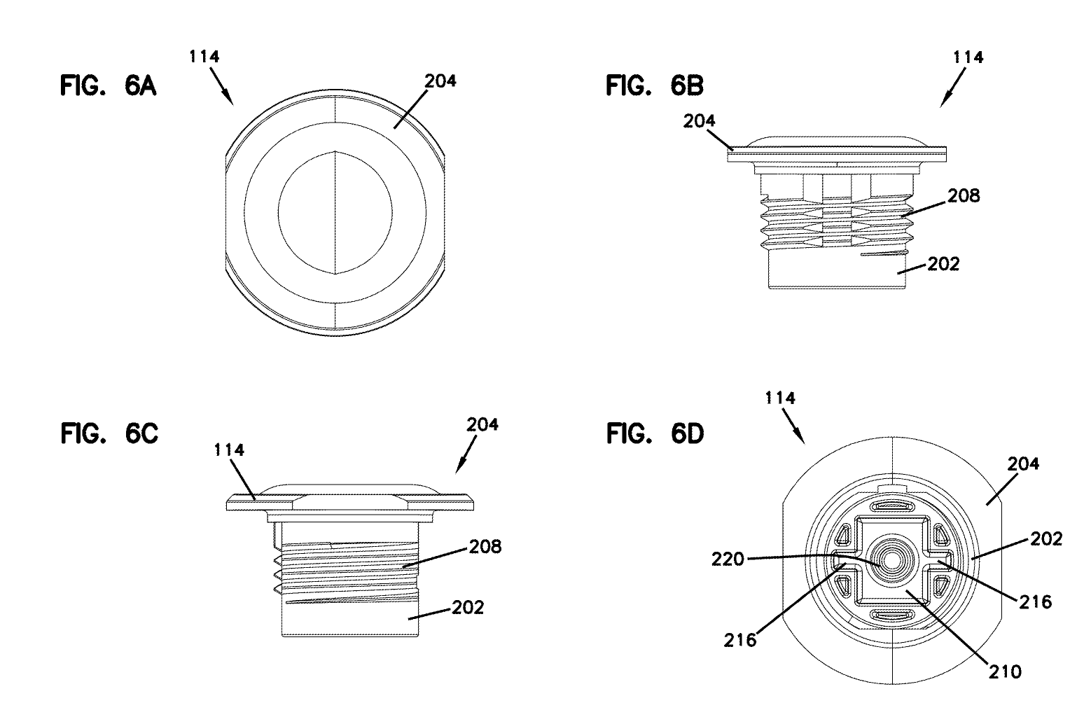

Referring to FIGS. 4-6, the enclosure port plug 114 is described in more detail. FIG. 5A schematically illustrates the enclosure port plug 114 engaging a fiber optic connector, and FIG. 5B schematically illustrates the enclosure port plug 114 before the fiber optic connector is inserted into the enclosure port plug 114. FIG. 6A is a top view of the enclosure port plug 114, FIG. 6B is a side view of the enclosure port plug 114, FIG. 6C is another side view of the enclosure port plug 114, and FIG. 6D is a bottom view of the enclosure port plug 114.

As illustrated in FIGS. 4-6, the enclosure port plug 114 includes a plug body 202 and a plug head 204. The plug body 202 extends from the plug head 204 and is configured to be inserted through the port 110 of the enclosure 102. The plug head 204 is larger than the port 110 of the enclosure to seat on a portion (e.g., an exterior surface) of the enclosure 102 circumferentially around the port 110 as the plug body 202 is inserted into the port 110. The plug head 204 is configured to completely cover the port 110 of the enclosure 102.

The enclosure port plug 114 is removably mounted at the enclosure port 110. In some embodiments, the enclosure port plug 114 is secured to the enclosure port 110 in the same manner as the fiber optic adapter 112. For example, the enclosure port plug 114 can be secured to the enclosure 102 through the enclosure port 110 by sandwiching the enclosure 102 between the plug head 204 and a mounting nut 206. In some embodiments, the mounting nut 206 is the same as the mounting nut 142 so that the mounting nut 206 that is used for the enclosure port plug 114 is used for the adapter 112, or vice versa. Corresponding to the mounting nut 206, the enclosure port plug 114 includes a threaded portion 208 on an external surface of the plug body 202, which is configured to engage the mounting nut 206 opposite to the plug head 204. When the enclosure port plug 114 is secured to the enclosure 102 through the enclosure port 110, the plug head 204 is arranged to outside the enclosure 102 and the mounting nut 206 is located inside the enclosure 102. In other embodiments, the enclosure port plug 114 is configured such that the enclosure port plug 114 is arranged inside the enclosure 102 while the mounting nut 206 is located outside the enclosure 102.

In other embodiments, the enclosure port plug 114 is snap-fit to the enclosure port 110. In yet other embodiments, the enclosure port plug 114 is threadedly engaged to (e.g., screwed in) the enclosure port 110. In yet other embodiments, the enclosure port plug 114 is secured to the enclosure port 110 in other suitable manners.

In some embodiments, a sealing element 226, such as O-ring, is provided between the plug 114 and the enclosure 102. For example, similarly to the sealing member 144 for the adapter 112, the sealing member 226 is provided to environmentally seal the plug 114 around the port 110 of the enclosure 102. In the illustrated example, the sealing member 226 is disposed between the enclosure 110 around the port 110 and the plug head 204.In other embodiments, where the enclosure port plug 114 is made of one or more elastomers or rubbers, which can provide sufficient sealing itself, the enclosure plug 114 can be sealingly engaged with the port 110 without additional sealing elements.

In some embodiments, the enclosure port plug 114 is configured as a single piece. In other embodiments, the enclosure port plug 114 is configured with a plurality of pieces that are assembled. For example, the plug body 202 and the plug head 204 are formed separately and combined to make the enclosure port plug 114. The enclosure port plug 114 can be made of one or more of various polymeric materials, such as plastic or rubber.

Referring to FIG. 5B, the plug body 202 defines a receiving cavity 210 therewithin that is configured to receive a connector, such as the first fiber optic connector 126. The receiving cavity 210 extends along a plug axis A within the plug body 202. The plug axis A can be coaxial with, or parallel with, an insert axis along which the connector 126 is inserted into the enclosure port plug 114.

The plug body 202 includes a connector support portion 212 within the receiving cavity 210. The connector support portion 212 is configured to receive and support at least a portion of the first connector 126 therein. In some embodiments, the connector support portion 212 is configured to generally conform to a shape of at least a portion of the first connector 126 that is inserted into the receiving cavity 210. In the illustrated example, where the first connector 126 has four lateral sides 214A-D (i.e., a rectangular or square cross section), the connector support portion 212 has four sides 212A-D corresponding to the lateral sides 214A-D of the first connector 126.

In some embodiments, the connector support portion 212 engages the first connector 126 by interference-fit (e.g., friction fit). In other embodiments, other mechanisms can be provided to support the first connector 126 within the connector support portion 212.

The plug body 202 can include one or more keying slots 216 configured to receive a corresponding rail 218 provided in the first connector 126. In some embodiments, the keying slots 216 and the rail 218 are formed substantially in parallel with the longitudinal axis A. Either of the keying slots 216 operate to guide the first connector 126 by receiving the rail 218 of the first connector 126 as the first connector 126 is inserted into the receiving cavity 210, and secure the first connector 126 within the receiving cavity 210 when the first connector 126 is inserted into the receiving cavity 210.

The plug body 202 can further include a ferrule support sleeve 220 configured to receive and support a ferrule 222 of the first connector 126 when the first connector 126 is received into the receiving cavity 210. In some embodiments, the ferrule support sleeve 220 extends within the receiving cavity 210 and defines an inner passage 224. As the first connector 126 is inserted in the receiving cavity 210, the ferrule 222 of the first connector 126 slides into the passage 224 of the ferrule support sleeve 220. In some embodiments, the passage 224 of the ferrule support sleeve 220 conform to, fit snugly, or form-fitting, against the outer surface (e.g., side wall) of the ferrule 222. The ferrule support sleeve 220 can form an airtight seal about the ferrule 222. In some embodiments, the ferrule support sleeve 220 is resilient and elastic, and the inner diameter of the ferrule support sleeve 220 is substantially the same as or less than the outer diameter of the ferrule 222. In some embodiments, the passage 224 of the ferrule support sleeve 220 is sized and configured to resist or even prevent insertion of a ferrule with a dust cap thereon into the ferrule support sleeve 220.

The enclosure port plug 114 is used to be at least partially inserted into the port 110 of the enclosure 102 to cover the port 110. When a fiber optic connection is needed through the particular port 110, the enclosure port plug 114 is removed from the port 110, and replaced by a fiber optic adapter 112. As such, the enclosure port plug 114 is designed to delay a fiber optic connection until the plug 114 is replaced by a fiber optic adapter 112 for mating fiber optic connectors.

Further, one or more enclosure port plugs 114 can engage one or some of the ports 110 defined in the fiber optic enclosure 102, thereby adjusting the number of ports 110 available for fiber optic connections through fiber optic adapters 112. Accordingly, the fiber optic connection system can provide different ports counts for fiber optic connections with a single fiber optic enclosure 102.

In certain examples, the enclosure port plug 114 is configured as a parking device for temporarily storing a fiber optic connector within the enclosure 102 until the fiber optic adapter 112 replace the enclosure port plug 114.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

### LIST OF REFERENCE NUMERALS AND CORRESPONDING FEATURES

100 fiber optic connection system
102 enclosure
104 base
106 housing
108 mounting portion
110 eight ports
112 adapter
114 enclosure port plug
120 input cable
122 input channel
124 fibers
126 first fiber optic connector
128 second fiber optic connector
140 adapter flange
142 mounting nut
144 sealing member
146 first receptacle
148 external port
150 adapter plug
152 threaded portion
154 threaded portion
156 O-ring
158 sealing surface
160 strap
162 alignment sleeve
164 threaded portion
202 plug body
204 plug head
206 mounting nut
208 threaded portion
210 receiving cavity
212A sides
212 connector support portion
214A lateral sides
216 keying slots
218 rails
220 ferrule support sleeve
222 ferrule
224 inner passage

1. A fiber optic connection system comprising:
an enclosure including a plurality of ports;
at least one enclosure port plug configured to be removably secured at the ports; and
at least one adapter configured to be removably mounted to at least one of the ports that does not secure the at least one enclosure port plug.

2. The fiber optic connection system according to claim 1, wherein:
the at least one adapter is configured to mate a first fiber optic connector and a second fiber optic connector, the adapter having a first receptacle and a second receptacle, the first receptacle open to an interior of the enclosure and configured to engage the first fiber optic connector, and the second receptacle open to an exterior of the enclosure and configured to engage the second fiber optic connector; and
the at least one enclosure port plug configured to be inserted into the port from the exterior of the enclosure and including a receiving cavity configured to engage the first fiber optic connector, the enclosure port plug further including a ferrule support sleeve arranged at the receiving cavity and configured to receive and support a ferrule of the first fiber optic connector when the fiber optic connector is received into the receiving cavity.

3. The fiber optic connection system according to claim 1, wherein:
the enclosure port plug is secured to the port in the same manner as the adapter.

4. The fiber optic connection system according to claim 1, further comprising:
at least one mounting nut configured to secure the adapter at the port,
wherein the enclosure port plug is secured at the port with the mounting nut.

5. The fiber optic connection system according to claim 1, wherein:
the enclosure port plug is threadedly engaged with the port.

6. The fiber optic connection system according to claim 1, wherein:
the plug is snap-fit to the port.

7. The fiber optic connection system according to claim 1, wherein:
the enclosure port plug includes:
a plug head configured to cover the port; and
a plug body extending from the plug head and configured to be inserted through the port.

8. The fiber optic connection system according to claim 7, wherein the enclosure port plug is secured to the enclosure through the port by sandwiching the enclosure between the plug head and a mounting nut, the plug head configured to seat on a portion of the enclosure 102 circumferentially around the port, and the mounting nut being located inside the enclosure.

9. The fiber optic connection system according to claim 8, further comprising a sealing element disposed between the enclosure port plug and the enclosure.

10. The fiber optic connection system according to claim 8, wherein:
the plug body defines a receiving cavity and includes a connector support portion within the receiving cavity, the connector support portion configured to receive and support at least a portion of the first fiber optic connector.

11. The fiber optic connection system according to claim 10, wherein:
the connector support portion engages the fiber optic connector by interference-fit.

12. A method for managing fiber optic connection, the method comprising:
engaging a first plug with a first port defined in a fiber optic enclosure to close the first port;
engaging a first fiber optic adapter with a second port defined in the fiber optic enclosure, the first fiber optic adapter configured to mate one of first fiber optic connectors and one of second fiber optic connectors, the first fiber optic connectors configured to be inserted into the first fiber optic adapter from an interior of the enclosure, and the second fiber optic connectors configured to be inserted into the first fiber optic adapter from an exterior of the enclosure; and
inserting one of the first fiber optic connectors to a receiving cavity of the first plug such that a ferrule of the one of the first fiber optic connectors is received and supported by a ferrule support sleeve arranged at the receiving cavity.

13. The method according to claim 12, further comprising:
removing the first plug from the first port; and
engaging a second fiber optic adapter with the first port, the second fiber optic adapter configured to mate one of the first fiber optic connectors and one of the second fiber optic connectors.

14. The method according to claim 12, further comprising:
inserting one of the first fiber optic connectors to the first plug.

15. A fiber optic plug for providing a delayed fiber optic connection, the fiber optic plug comprising:
a plug head configured to cover an adapter port of a fiber optic enclosure the adapter port configured to secure a fiber optic adapter;
a plug body extending from the plug head and configured to be inserted through the adapter port, the plug body defining a receiving cavity and including a connector support portion within the receiving cavity, the connector support portion configured to receive and support at least a portion of the fiber optic connector, and the plug body further including a ferrule support sleeve configured to receive and support a ferrule of the fiber optic connector when the fiber optic connector is received into the receiving cavity.

16. The fiber optic plug according to claim 15, wherein:
the connector support portion engages the fiber optic connector by interference-fit.
